(19) United States
(12) Patent Application Publication
(10) Pub. No.: US 2009/0089330 A1
(43) Pub. Date: Apr. 2, 2009

(54) Order entry system

(76) Inventor: George M. Vodin, Palatine, IL (US)

Correspondence Address: FACTOR & LAKE, LTD, 1327 W. WASHINGTON BLVD., SUITE 5G/H, CHICAGO, IL, 60607, US

(21) Appl. No.: 11/906,148

(22) Filed: Sep. 27, 2007

(51) Int. Cl. G06F 17/00

(52) U.S. Cl. 707/104.1

(57) ABSTRACT

An automated order entry system is provided for entering orders for artwork framing. The system can include a computer and a handheld computer. The computer includes a store or franchise database containing pricing information for artwork framing. The handheld computer includes a scanner and a portable database synchronized with the store database. Furthermore, information scanned from a frame sample corresponds with information contained in the portable database.

### CROSS-REFERENCE TO RELATED APPLICATIONS

None.

### TECHNICAL FIELD

The present invention is directed to an automated order entry system, and more specifically to an order entry system for artwork framing.

### BACKGROUND OF THE INVENTION

Currently, ordering a custom frame for a piece of artwork requires several steps. First, the client chooses from various items and features in designing the frame. This selection process is usually done at a store where the client can view a variety of different frame styles and features.

The selected items are then recorded and the total price is calculated by a store clerk on a preprinted work order form. Next, the form is sent to a craftsman for assembling the frame. The craftsman can be located on the store premises or offsite.

Upon completion of the frame per the work order, the client is notified that the frame is ready for delivery. Accordingly, the client returns to the store to pickup the frame.

### SUMMARY OF THE INVENTION

A system is provided for automated order entry of artwork framing. In an embodiment, the system includes a store computer, such as a personal computer, and a point of sale device, such as a handheld computer. The store computer includes a store or franchise database containing data such a client list, art inventory, and batched orders transferred to a server. Further, the handheld computer includes a portable database containing data synchronized with at least a portion of the store computer database.

In yet another embodiment, the system includes a computer having a store or franchise database containing pricing information for artwork framing. Further, a handheld computer is provided having a scanner and a portable database synchronized within at least a portion of the information contained in the store computer database.

In a further embodiment, the system includes a store computer and a handheld computer. The store computer includes a database containing customer and order information for artwork framing. The handheld computer includes a scanner and a portable database synchronized with the store database. Furthermore, information scanned from a frame sample corresponds with information contained in the portable database.

Other embodiments, systems, methods, features, and advantages of the present invention will be, or will become, apparent to one having ordinary skill in the art upon examination of the following drawings and detailed description. It is intended that all such additional systems, methods, features, and advantages included within this description be within the scope of the present invention, and can be protected by the accompanying claims.

### BRIEF DESCRIPTION OF THE DRAWINGS

The invention may be better understood with reference to the following drawings. The components in the drawings are not necessarily to scale, emphasis instead being placed upon illustrating the principles of the invention. In the drawings, like reference numbers designate corresponding parts throughout.

FIG. 1 is a simplified functional block diagram of an order entry system in accordance with the present invention comprising a handheld computer having an application loaded thereon;

FIG. 2 is a login screen provided on the display of the handheld computer of FIG. 1;

FIG. 3 is a framing parameters data entry screen provided on the display of the handheld computer of FIG. 1;

FIG. 4 is a quote lookup screen provided on the display of the handheld computer of FIG. 1;

FIG. 5 is art lending order data entry form provided on the display of the handheld computer of FIG. 1;

FIG. 6 is a matting parameters data entry form provided on the display of the handheld computer of FIG. 1;

FIG. 7 is a molding and glazing parameters data entry form provided on the display of the handheld computer of FIG. 1;

FIG. 8 is a ruling lines data entry form provided on the display of the handheld computer of FIG. 1;

FIG. 9 is a v-groove data entry form provided on the display of the handheld computer of FIG. 1;

FIG. 10 is an ancillary services data entry form provided on the display of the handheld computer of FIG. 1;

FIG. 11 is a special instructions data entry form provided on the display of the handheld computer of FIG. 1;

FIG. 12 is a graphic data entry form provided on the display of the handheld computer of FIG. 1;

FIG. 13 is an order summary provided on the display of the handheld computer of FIG. 1;

FIG. 14 is a check out data entry screen provided on the display of the handheld computer of FIG. 1;

FIG. 15 is a work order summary form provided on the display of the handheld computer of FIG. 1;

FIG. 16 is a cost analysis form provided on the display of the handheld computer of FIG. 1;

FIG. 17 is a running total form provided on the display of the handheld computer of FIG. 1; and,

FIG. 18 is a block diagram of a customer invoice printed by the system of FIG. 1.

### DETAILED DESCRIPTION

The following descriptions of detailed embodiments are for exemplifying the principles and advantages of the inventions claimed herein. They are not to be taken in any way as limitations on the scope of the inventions.

When considering custom framing, there are many different treatments that can be applied to a work of art; each with its own distinct characteristics and attributes that set it apart from all others. Each of these treatments employs different materials that can vary in size, color, shape, texture and cost. To this end, in an embodiment, an automated point of sale order entry system is provided that is simple to understand, capable of branching in different directions according to the customer's requisites, flexible enough to make changes on the fly as well as nimble enough to recall quotes and traverse through multiple orders for making alterations, additions or deletions.

In an embodiment, a system is provided that includes a server, a personal computer and a point of sale device such as a handheld computer. In the system, the server, personal computer and point of sale device are linked to one another in a hierarchical fashion to provide for ordering and processing artwork frames.

Preferably, the handheld computer is a stand alone device that collects data as it guides the customer, via a sales associate, through the frame ordering process. In creating an order, the screens (i.e., data entry forms) provided by the handheld computer can branch in different directions according to the customer's preferences.

In an embodiment, the handheld computer can perform calculations for determining the price of the frame and creates a work order containing data regarding the customer's order. The handheld computer can also provide for traversing back and forth through screens (e.g., data entry forms and summaries) regarding the order or other orders. Thus, the sales associate can make changes, additions or deletions, as requested by the customer. Further, the handheld computer can display a work order report that details the elements and dimensions of the order as well as a pricing analysis that breaks down the cost of the elements in the order.

Once the order had been finalized, the sales associate proceeds to a checkout screen and enters the customer's phone number, at which point the order can be recorded either as a sale or a quote. In an embodiment, at this point data can be transferred from the handheld computer to the personal computer either by placing the handheld computer in a cradle or via infrared or other conventional wireless data transmission means. Then, with a data synchronization screen displayed on the personal computer, the personal data and invoice screen data from the handheld computer is transferred to the personal computer. Moreover, the transferred personal data and invoice data is displayed on the monitor of the personal computer and a customer invoice or summary of the order is printed out for review by the customer wherein the customer can sign the summary to indicate his or her understanding and approval of the order.

In an embodiment, if the customer is a previous customer, then their personal information is automatically filled-in on both the monitor of the personal computer and the printed summary of the order. If not, then the customer can be asked by the sales associate to complete their personal information on the printed sheet. In this way, the associate can enter the customer's personal data into the database of the personal computer at a later time when it is a convenient time for the associate.

Preferably, each order is reviewed by the sales associate to verify that the entered dimensions are correct, and to make any alterations if necessary, and to signoff on the order. When the order is completed, it is accepted into a batch file in the database where it is uploaded to a server for processing. Since it is possible for each store to charge more or less than the recommended pricing inherent to the handheld device, each order can be filtered through by the server using the recommended pricing, in this way creating a standard for billing purposes.

A work order can be created by the server that compartmentalizes each set of the building process wherein each step that can be signed off by the worker that completes it at a local or remote workstation or shop. Additionally, inventory can be checked for all of the elements and an order list can be made by the server for any items that may be out of stock. Further, as each segment of the order is completed, inventories for those items in that segment can be adjusted in the database.

Once the order is completed it can be signed off and removed from the work order queue of the server and placed in the customer pickup queue of the database of the personal computer. When each item is picked up by the customer, it is checked off and time stamped; the account balance will also be displayed, so that any money which is due can be collected.

In an embodiment, the personal computer in the system includes and maintains local databases for both customers and inventory for a store location. Data between the personal computer and the handheld computer can be interchanged regularly for updating the information for the associated store. Other information such as: store number, address, sales tax percentage, manager password as well as other confidential information can be completed on the personal computer.

In an embodiment, the server in the system collected data from one or more personal computers for the management of work orders, accounting, billing, and distribution of software updates.

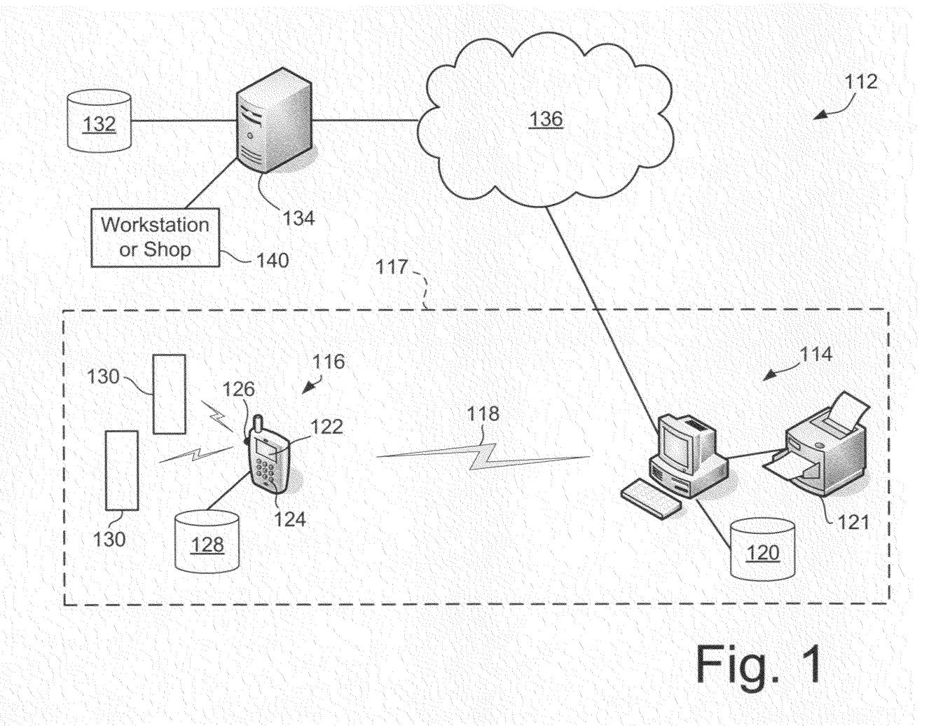

Turning to FIG. 1, a simplified block diagram is provided of a system in accordance with the present invention. The system 112 includes a personal computer 114 and a handheld computer 116. As explained in detail further herein, data between the computers 114,116 can be synchronized via a communication link 118.

Preferably, but not necessarily, computers 114 and 116 are associated with a single store or retail outlet 117. In an embodiment, the store can be all or part of a franchise. In an embodiment, but not necessarily, the computer 114 is located on the premises of the store 117. However, the handheld computer can be used both on and off the premises of the store 117.

The personal computer 114 is a conventional device having a memory or database 120 associated therewith. Preferably, but not necessarily, the personal computer 114 uses an operating system such as WINDOWS by Microsoft Corp., Redmond, Wash. Further, the database 120 of the personal computer 114 can be separated into various sub-databases for maintaining, for example, an inventory, order information and customer database.

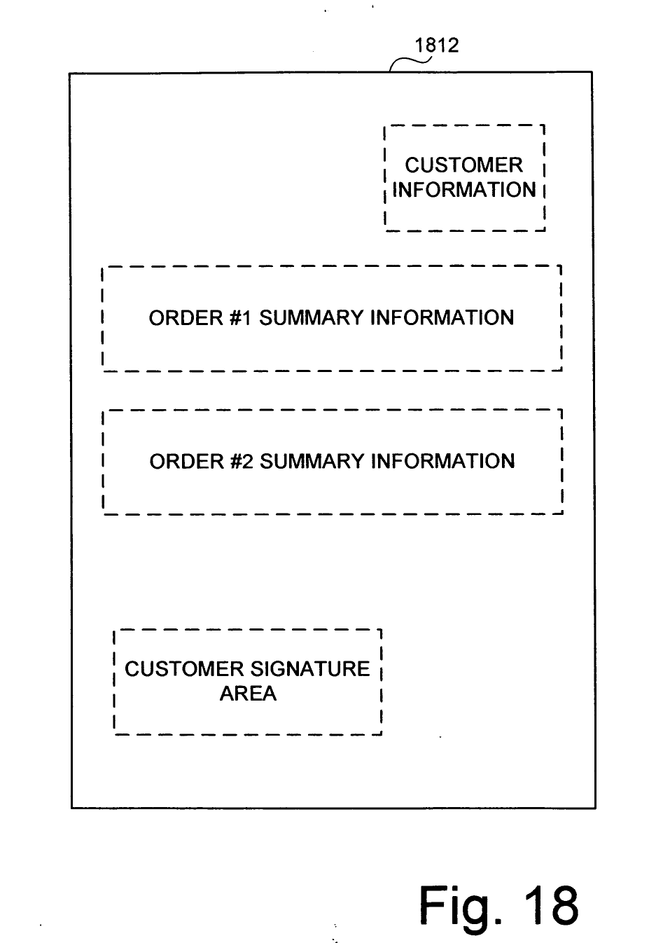

The personal computer 114 is connected to a printer 121. As previously stated above, the printer 121 provides for printing customer invoices or work orders 1812 as depicted in FIG. 18.

In an embodiment, the handheld computer 118 is a HP JORDADA 720 by Hewlett-Packard Co., Palo Alto, Calif. Accordingly, the handheld computer is a conventional device that includes a display 122, a keyboard 124, a barcode reader 126 and a memory 128. The barcode reader 126 can be an attachment to the handheld computer such as offered by Socket Mobile, Inc, Newark, Calif.

The display 122 and the keyboard 124 provide for a user interface with the handheld computer. Further, as explained in detail further herein, the barcode reader 126 provides for reading information from items 130 such as frame samples, prints, mats, or other goods.

As indicated previously, the databases 120,128 can be synchronized via communication link 118. Preferably, this operation is performed in a conventional manner wherein the link 118 can be hardwired or wireless. Data synchronized on the databases includes, but is not limited to, frame component pricing information.

In addition to synchronization between databases 120 and 128, data can also be synchronized between the store database 120 and a main database 132 associated with server 134. In this embodiment, the store computer 114 and the server 134 can be operatively connected together via a conventional local area network (LAN) or wide area network (WAN) 136 such as the Internet.

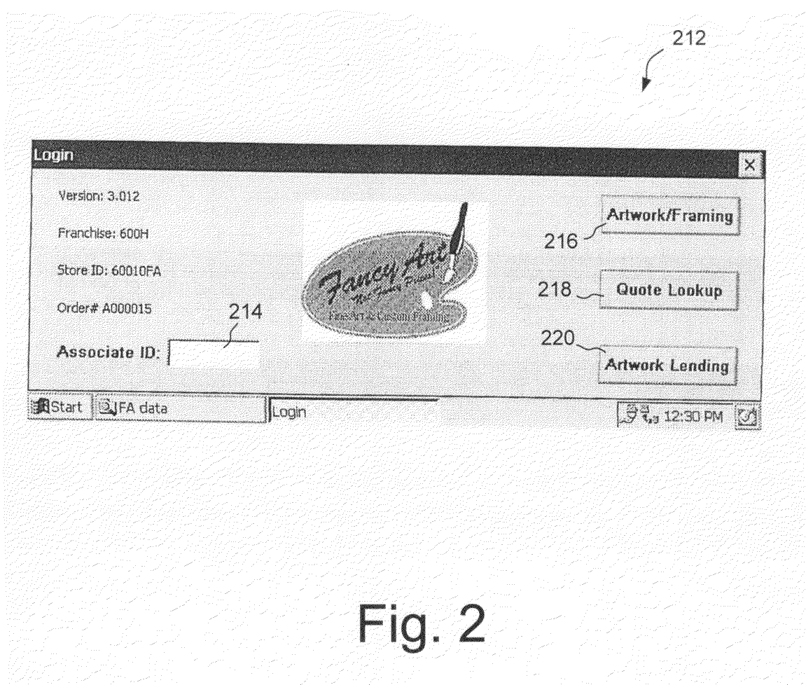

Loaded on the handheld computer 116 is a computer program or application for presenting the screens of FIGS. 2-17 on the display 122 of the computer 116. Turning to FIG. 2, a login screen 212 is provided for logging onto the handheld computer and includes information regarding the version number of the application, the franchise that the handheld computer is assigned to, the store that the handheld computer is assigned to, and an order number.

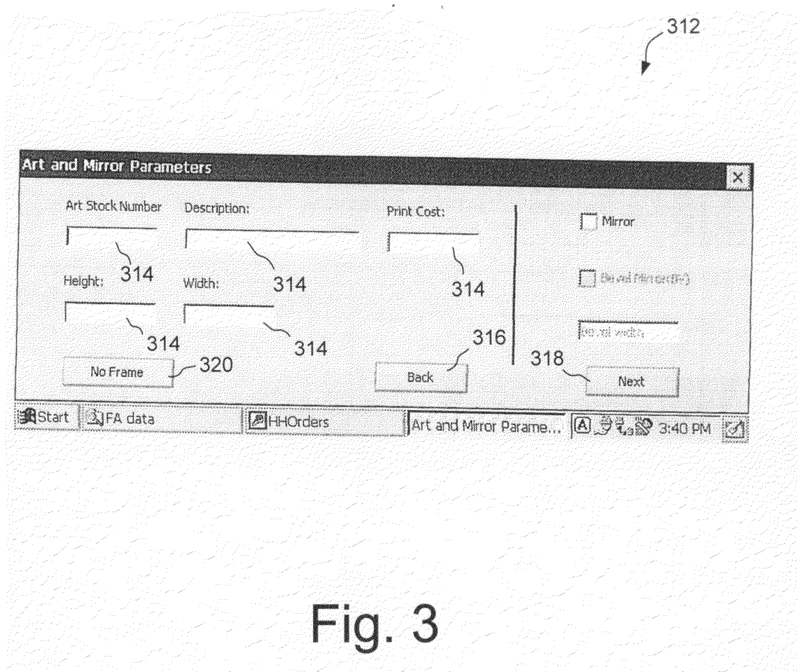

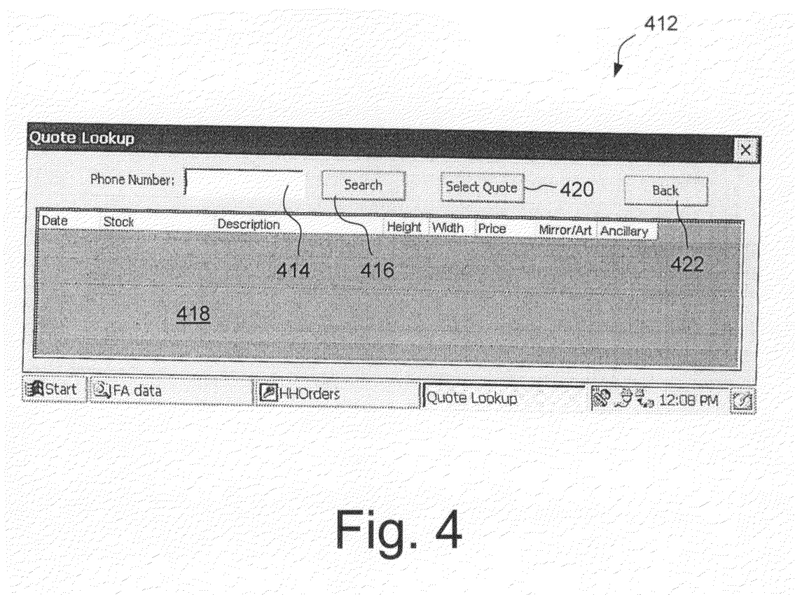

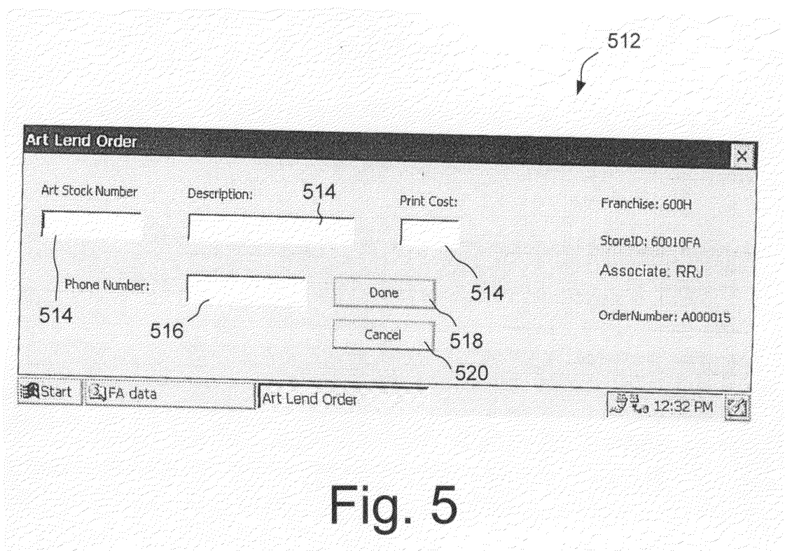

The login screen 212 also includes a data entry window or field 214 for entry of a sales associate identifier via the keyboard 124 of the handheld computer 116. Moreover, the login screen 212 includes buttons 216, 218 and 220 for transferring to a framing parameters data entry screen (FIG. 3), a quote lookup screen (FIG. 4), and an artwork lending data entry screen (FIG. 5), respectively. The buttons can be selected in a conventional manner such as by tapping the display 122 of the handheld computer 116 with a stylus.

Turning to FIG. 3, the framing parameters data entry screen 312 provides for entering basic framing parameters for ordering a frame. The frame can be for artwork, a mirror, or other items. In an embodiment, the form 312 includes windows 314 for entering an art stock number, a description, a print cost extracted from the onboard art inventory portion of the database if it is an in-stock item, a height size and a width size. Preferably, but not necessarily, one or more of the windows 314 can be selected using a stylus wherein data is entered into the window via the keyboard 124 of the handheld computer 116 or by scanning information via the scanner 126 (FIG. 1). In an embodiment, but not necessarily, the scanned information can include a barcode attached to a frame sample, print, or other item 130 (FIG. 1) wherein the data filled within the corresponding window is associated with the scanned barcode and obtained from the handheld computer database 128 (FIG. 1).

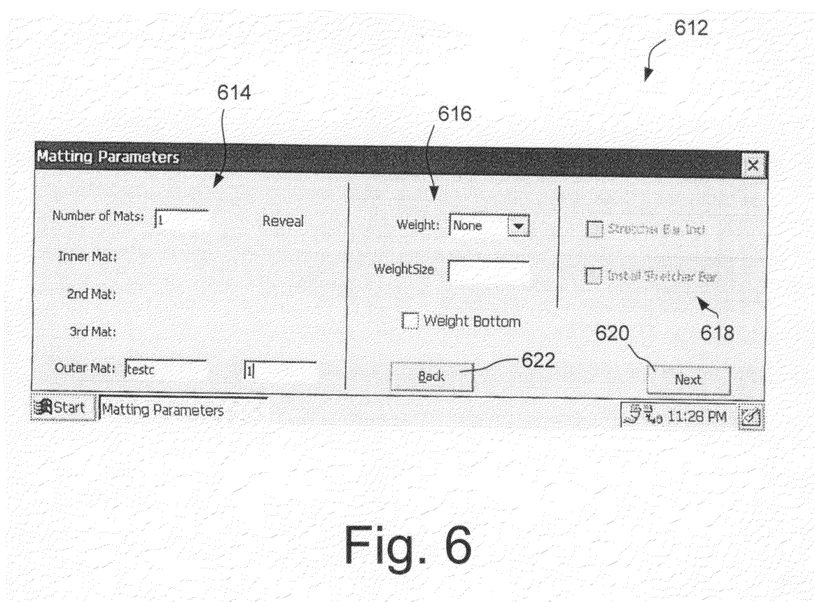

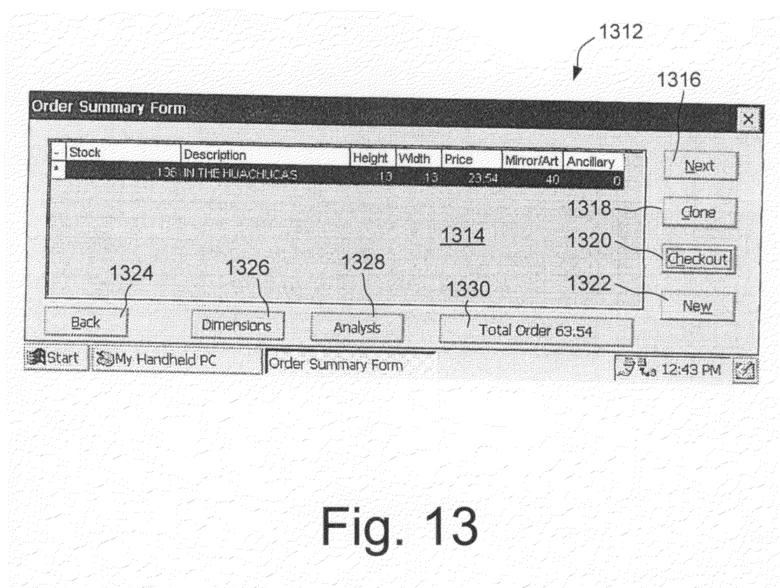

As also shown in FIG. 3, data entry screen 312 includes check boxes for selecting a mirror with or without a bevel along with a window for entering the bevel width. Further, the data entry screen 312 includes buttons 316, 318 and 320 for transferring to the previous login screen (FIG. 2), moving to the next screen (FIG. 6 for entering matting parameters), and moving to a screen (FIG. 13 for viewing the order summary) if no frame is required because only artwork is being purchased, respectively.

In an embodiment, if the user selects to move to the next screen (FIG. 6 for entering matting parameters) or move to a screen (FIG. 13 for viewing the order summary) if no frame is required, then the data entered on the data entry screen 312 is stored in the database 128 of the handheld computer 122.

Turning to FIG. 4, the quote lookup screen 412 provides for obtaining quote information from the database 128 on the handheld computer 116. The screen 412 provides a window or field 414 for entering a client's telephone number. Further, a button 416 is provided for searching for quotes within the database 128 that match the client's telephone number. If any quotes are found, then they are displayed on area 418.

The quote lookup screen also provides a button 420 for selecting a quote displayed in area 418. Once selected, the quote is flagged as an order and the form of FIG. 13 is displayed on the screen 122 of the handheld computer 116. Furthermore, a button 422 is provided for transferring back to the login screen (FIG. 2).

Turning to FIG. 5, an art lending order data entry form 512 is illustrated that is provided on the display 122 of the handheld computer 116 of FIG. 1. The form 512 provides for entering basic information for an art lend. In an embodiment, the form 512 can include a windows 514 for entering an art stock number, corresponding description and print cost. Further, a window 516 is provided for entering the client's telephone number.

Once the data is entered, a button 518 is provided for saving the order and returning to the login screen (FIG. 2). Alternatively, another button 520 is provided for canceling the order and then returning to the login screen.

Turning to FIG. 6, a matting parameters data entry form 612 is illustrated that is provided on the display 122 of the handheld computer 116 of FIG. 1. The form 612 provides for accepting matting information. In an embodiment, the form 612 can include an area 614 for entering the number of mats, type of mat, and the reveal for each. Another area 616 can also be provided for selecting the weighting option (e.g., none, horizontal or vertical), along with the weight size and bottom. Moreover, an area 618 can be provided on the form 612 for indicating that a stretcher is included by the customer or to be installed.

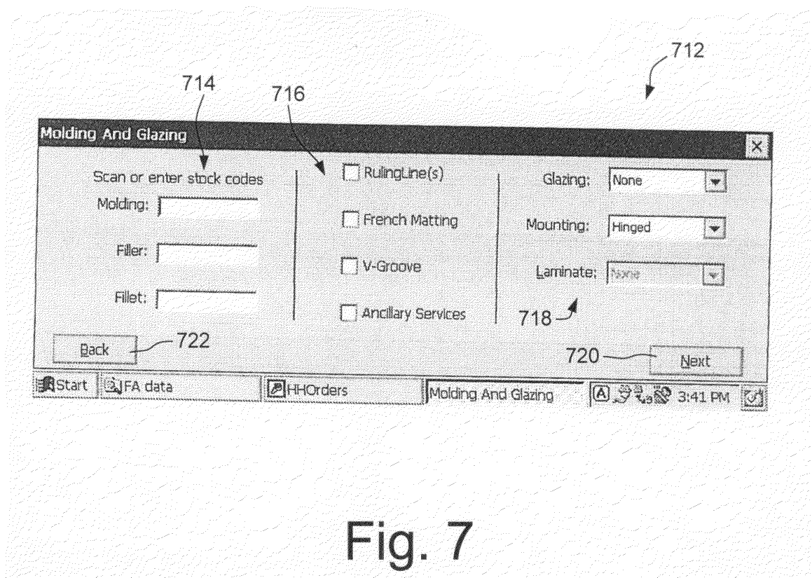

Once the data is entered in form 612, a button 620 is provided for saving the entered information and moving to a molding and glazing data enter form (i.e., FIG. 7). Alternatively, another button 622 is provided for returning to the framing parameters data entry screen 312 (FIG. 3).

Turning to FIG. 7, a molding and glazing data entry form 712 is illustrated that is provided on the display 122 of the handheld computer 116 of FIG. 1. The form 712 provides for entering additional framing information. In an embodiment, the form 712 provides an area 714 for entering molding, filler, or fillet stock codes. Also, an area 716 is provided for selecting options such as ruling lines, French matting, V-groves or ancillary services. Moreover, an area 718 is provided for selecting glazing, mounting, or laminate options.

In an embodiment, but not necessarily, the data entered in area 714 can comprise characters corresponding to the type and width of the selected molding. Accordingly, the total price for the selected molding, per foot, can be determined from a matrix containing per foot prices for various molding types and widths.

After the data is entered in form 712, a button 720 is provided for saving the entered information and moving to another screen corresponding to the selection in area 716. Alternatively, button 722 is provided for returning to the matting parameters data entry form 612 (FIG. 6).

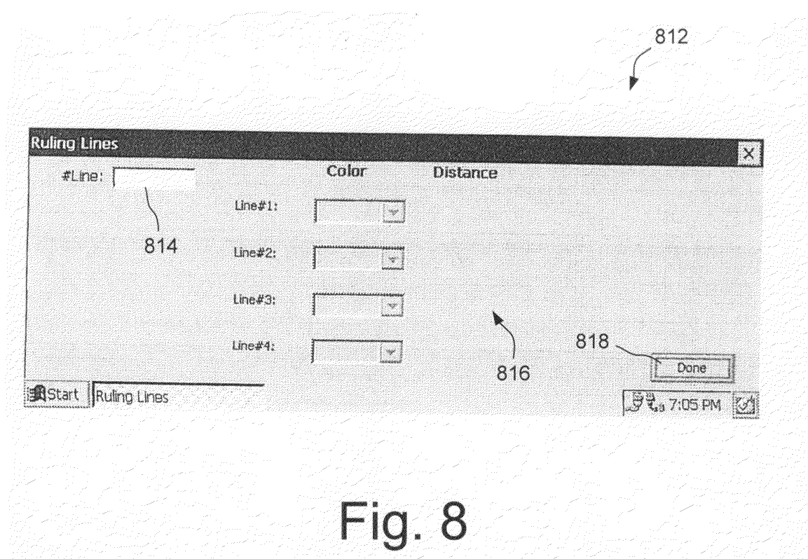

Turning to FIG. 8, a ruling lines data entry form 812 is illustrated that is provided on the display 122 of the handheld computer 116 of FIG. 1. The form 812 provides for entering ruling information and thus includes a window 814 for entering the number of lines. In addition, an area 816 is provided for entering the color and distance of each line. Once the data is entered into from 812, a button 818 is provided for returning to the molding and glazing data entry form 712 (FIG. 7).

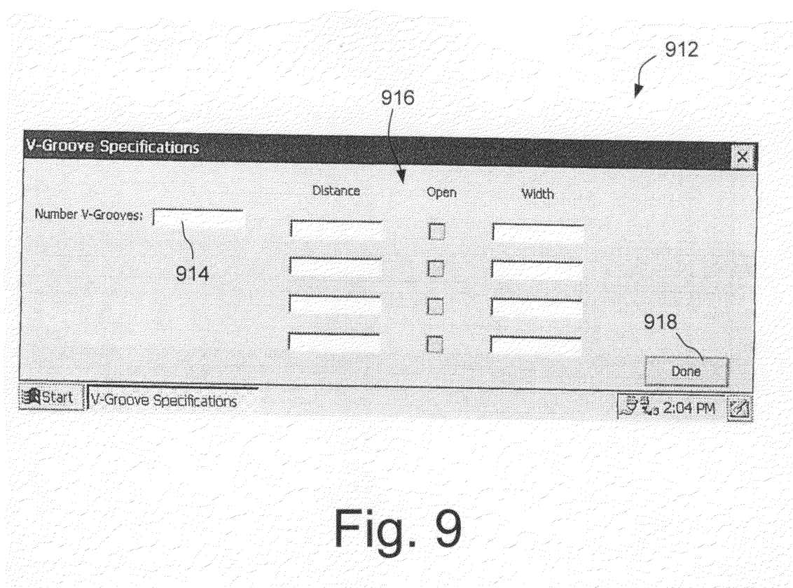

Turning to FIG. 9, a v-groove data entry form 912 is illustrated that is provided on the display 122 of the handheld computer 116 of FIG. 1. The form 912 provides for entering v-groove information. Accordingly, the form includes a window 914 for entering the number of v-grooves. Also, an area 916 is provided for entering distance, open and width for each groove. Finally, once the data is entered into form 912, a button 918 is provided for returning to the molding and glazing data entry form 712 (FIG. 7).

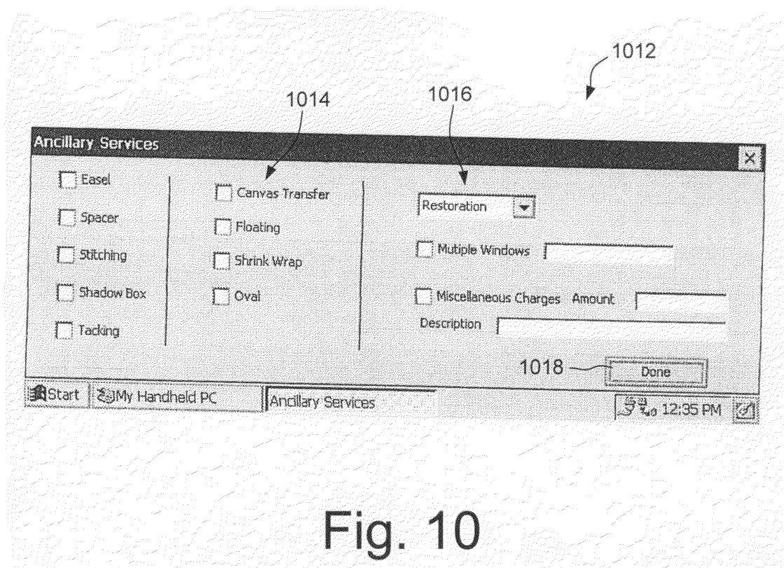

Turning to FIG. 10, an ancillary services data entry form 1012 is illustrated that is provided on the display 122 of the handheld computer 116 of FIG. 1. The form 1012 provides for entering various options. In an embodiment, the form 1012 includes an area 1014 for selecting options for an easel, spacer, stitching, shadow box, tacking, canvas transfer, floating, shrink wrap and oval. In addition, an area 1016 is provided for selecting restoration level, multiple windows and miscellaneous charges details. After data is entered into the form 1012, a button 1018 is provided for returning back to the molding and glazing data entry form 712 (FIG. 7).

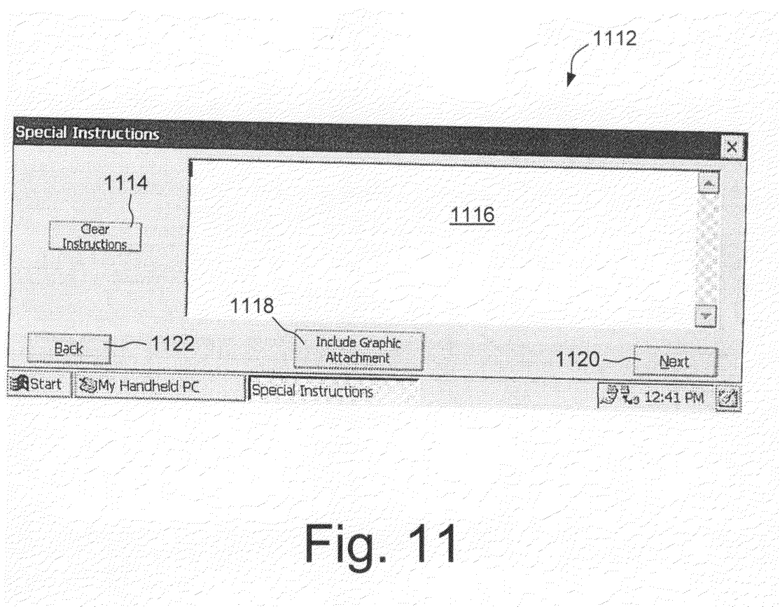

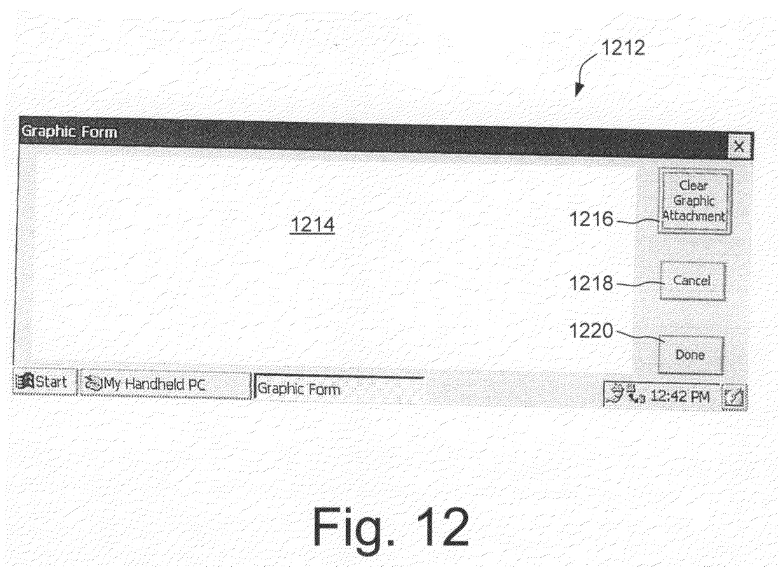

Turning to FIG. 11, a special instructions data entry form 1112 is illustrated that is provided on the display 122 of the handheld computer 116 of FIG. 1. The form 1112 provides for entering special instructions in area 1116. In an embodiment, the form 1112 includes a button 1114 for erasing special instruction text entered in area 1116. A button 1118 is also provided to include a graphic attachment by loading a graphic attachment form as depicted in FIG. 12. After the special instructions are entered in form 1112, a button 1120 is provided on the form for transferring to the order summary form depicted in FIG. 13. Alternatively, a button 1122 is provided for returning the user back to the molding and glazing data entry form 712 of FIG. 7.

Turning to FIG. 12, a graphic attachment data entry form 1212 is illustrated that is provided on the display 122 of the handheld computer 116 of FIG. 1. The form 1212 provides for sketching a special instruction diagram in area 1214. A button 1216 is provided for erasing the sketch entered in area 1214. In addition, buttons 1218 and 1220 are provided for returning to the special instructions form 1112 (FIG. 11) wherein selection of button 1220 results in the data entered in area 1214 being saved in memory 128 (FIG. 1).

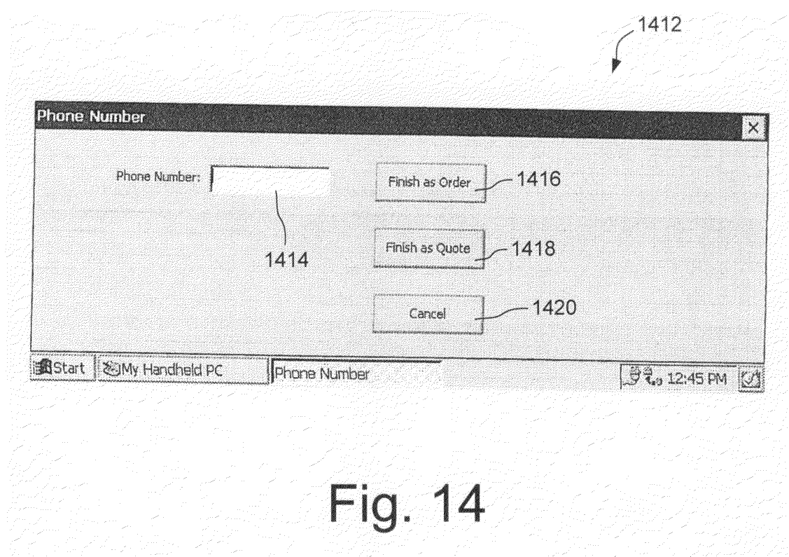

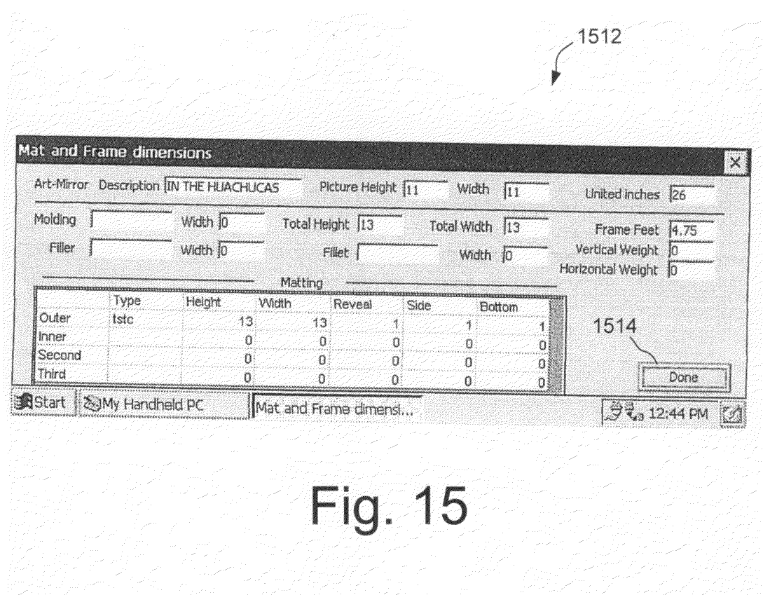

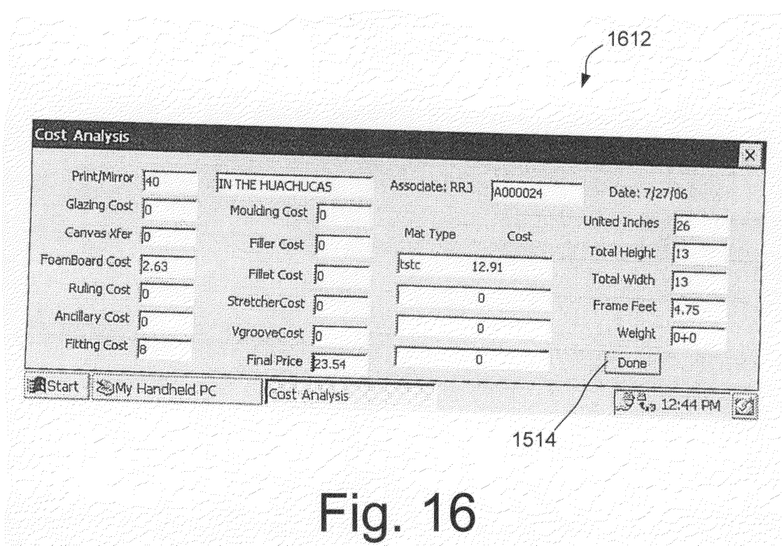

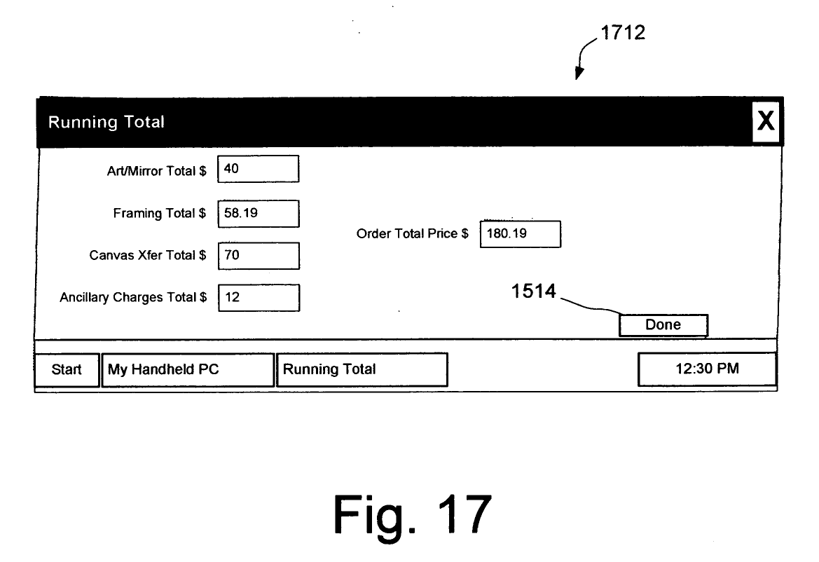

Turning to FIG. 13, a order summary form 1312 is illustrated that is provided on the display 122 of the handheld computer 116 of FIG. 1. The form 1312 is provided for displaying and accepting order options. In an embodiment, the form 1312 displays current order information in area 1314 as line item parameters. A button 1316 is provided for obtaining another order item after clearing line item parameters. Another button 1318 is provided copying last item parameters (i.e., matting and molding options) and transferring to the framing parameters data entry form 312 (FIG. 3). Yet another button 1320 is provided for transferring to the phone number data entry form 1412 (FIG. 14). Further, a button 1322 is provided to clear the current order details and transferring to the login form 212 (FIG. 2) for entering a new order. In addition, a button 1324 is provided for returning back to the special instructions data entry form 1112 (FIG. 11). Also, buttons 1326 and 1328 are provided for transferring to the dimension form 1512 (FIG. 15) and the cost analysis form 1612 (FIG. 16). Finally, a button 1330 is provided that displays the sum of charges for all selected lines and, by selecting the button, transfers to the running total form 1712 of FIG. 17.

Turning to FIG. 14, a phone number data entry form 1412 is illustrated that is provided on the display 122 of the handheld computer 116 of FIG. 1. The form 1412 is provided for entering a telephone number for an order. In an embodiment, a window 1414 is provided for entering the telephone. In addition, buttons 1416 and 1418 are provided for entering data as an order or quote, respectively, into the database 128 (FIG. 1) of the handheld computer 116. Further, a button 1420 is provided for returning to the order summary form 1312 (FIG. 13).

Turning to FIGS. 15, 16 and 17, these forms provide information regarding mat and frame dimensions, cost analysis, and running total, respectively, of the line item selected from the order summary form 1312 of FIG. 13. Moreover, each of these forms includes a button 1514 for returning to the order summary form 1312.

Accordingly, by using the system described above, data for ordering a frame is entered to the memory 128 of the handheld computer 116. This data can be synchronized, on a delayed basis or in real-time, with the memory 120 of the store computer 114. In addition, information can be transferred by the store computer 114, via the LAN or WAN 136 (e.g., the Internet), to the server 134 and from there to various facilities such as a local or remote workstation or shop 140 for completing the order. In an embodiment, but not necessarily, the local workstation 140 can be located on the same premises as the store 117.

It should be emphasized that the above-described embodiments of the present invention, particularly, any “preferred” embodiments, are possible examples of implementations merely set forth for a clear understanding of the principles for the invention. Many variations and modifications may be made to the above-described embodiment(s) of the invention without substantially departing from the spirit and principles of the invention. All such modifications are intended to be included herein within the scope of this disclosure and the present invention, and protected by the following claims.

What is claimed is:

1. A system comprising:
a computer comprising a store or franchise database containing data;
a handheld computer comprising a portable database containing data synchronized at least in part with the store database; and,
wherein the store database includes artwork framing order data originally entered into the handheld computer.

2. The system of claim 1, the handheld computer further comprising a scanner.

3. The system of claim 2, wherein information scanned from a frame sample corresponds with at least a portion of the data contained in the portable database.

4. The system of claim 1, further comprising a main computer comprising a main database synchronized with at least a portion of the data contained in the store database.

5. The system of claim 1, further comprising a menu driven order entry program loaded on the handheld computer.

6. The system of claim 1, wherein the menu driven order entry system provides for obtaining quotes and artwork lending orders.

7. The system of claim 1, further comprising a customer invoice created, at least in part, from the information entered into the handheld computer.

8. A system comprising:
a computer comprising a store or franchise database containing customer and order information for artwork framing; and,
a handheld computer comprising a scanner and a portable database synchronized with at least a portion of the information contained in the store database.

9. The system of claim 8, wherein information scanned from a frame sample corresponds with at least a portion of the data contained in the portable database.

10. The system of claim 8, further comprising a main computer comprising a main database synchronized with at lease a portion of the data contained in the store database.

11. The system of claim 8, further comprising a menu driven order entry program loaded on the handheld computer.

12. The system of claim 8, wherein the menu driven order entry system provides for obtaining quotes and artwork lending orders.

13. The system of claim 8, further comprising a customer invoice created, at least in part, from information entered into the handheld computer.

14. A system comprising:
a computer comprising a store or franchise database containing pricing information for artwork framing;
a handheld computer comprising a portable database synchronized with the store database and a scanner; and,
wherein information scanned from a frame sample corresponds with information contained in the portable database.

15. The system of claim 14, further comprising a main computer comprising a main database synchronized with the information contained in the store database.

16. The system of claim 14, further comprising a menu driven order entry program loaded on the handheld computer.

17. The system of claim 14, wherein the menu driven order entry system provides for obtaining quotes and artwork lending orders.

18. The system of claim 14, further comprising a customer invoice created, at least in part, from information entered into the handheld computer.

19. The system of claim 18, wherein the customer invoice includes a designated area for a customer to sign.
